(19) United States
(12) Patent Application Publication
(10) Pub. No.: US 2026/0348364 A1
(43) Pub. Date: Nov. 5, 2026

(54) DRIVE DEVICE HAVING A MAIN BODY AND HAVING AT LEAST ONE ROTATING UNIT

(71) Applicant: JSM GmbH, Meile (DE)

(72) Inventor: Jochen Schleef, Meile (DE)

(21) Appl. No.: 19/148,082

(22) PCT Filed: Jan. 23, 2024
(86) PCT No.: PCT/EP2024/051474

§ 371 Date: Jul. 15, 2025

(30) Foreign Application Priority Data
Jan. 25, 2023 (DE) 10 2023 101 771.3

(51) Int. Cl. F03G 3/00

(52) U.S. Cl. CPC F03G 3/091; F05B 2260/422

(57) ABSTRACT

A drive device having a main body and having at least one rotating unit, the rotating unit having at least one driven drive shaft, the drive shaft driving at least one rotating body, the rotating body having at least two swing weights, the swing weights being arranged to be movable radially relative to the drive shaft, the swing weights being arranged on opposite sides of the drive shaft, and the swing weights being connected at a fixed distance. The rotating body has at least two pulse generators, the rotating body has at least one linear guide for guiding the at least two pulse generators radially relative to the drive shaft, the pulse generators are arranged on opposite sides of the drive shaft, at least one spring element is arranged in each case between the pulse generators and the drive shaft, the spring elements are each designed to deflect each pulse generator, the rotating unit has at least one link plate for controlling the distance between the pulse generators and the drive shaft, and the pulse generators are associated with the swing weights so as to transmit pulses.

### BACKGROUND OF THE INVENTION

### Field of the Invention

The invention relates to a drive device having a main body and having at least one rotating unit, wherein the rotating unit is arranged at least in a rotatable manner on the main body, wherein the rotating unit has at least one driven drive shaft, wherein the drive shaft drives at least one rotating body, wherein the rotating body has at least two swing weights, wherein the swing weights are arranged to be radially movable to the drive shaft, wherein the swing weights are arranged in pairs, wherein the swing weights are arranged on opposite sides of the drive shaft and wherein the swing weights are connected to each other at a fixed distance from each other.

### Brief Discussion of the Related Art

Drive devices are used in a wide range of applications, for example, for vehicles as well as remote-controlled or autonomous vehicles. When operating land vehicles with drive wheels, hazards can arise due to aquaplaning, ice-covered roads or the like when the tyres come into contact with the road. In addition, the permanent contact of the tyres with the road surface can lead to signs of wear and tear of the tyres.

For example, DE 10 2019 126 489 A1 is known to have a drive device having a main body and having at least two rotating units, wherein the rotating units are arranged on the base plate in a rotatable manner at least, wherein the rotating units each have at least two rotating shafts driven in the opposite direction of rotation. Each rotating shaft drives at least one rotating body, wherein the rotational planes of the rotating bodies of a rotating unit are arranged parallel to each other. Each rotating body has at least one swing weight and the swing weights are each mounted radially to the rotating shaft. In one section of the rotation, there is a swing weight in the area of the drive shaft and the second swing weight is in an unbalanced position. The swing weights can be shifted radially to the rotational axis on the rotating bodies in such a way that there is an imbalance in a circular segment of the same rotation and that a balanced movement is possible in another circular segment of a revolution. The imbalances should be carried out in the same direction for all rotating bodies and all rotating units so that there is a pulse of the main body in one direction.

The precise and robust control and generation of the pulses of the swing weights is of great importance for the efficient functioning of the drive device due to the high level of acting forces.

### SUMMARY OF THE INVENTION

The object of the invention is to propose a drive device of the type mentioned in which robust control of the pulses of the swing weights is possible in a simple way.

This task is solved by means of providing a drive device with the features of the independent claim(s). Further embodiments and favourable embodiments are specified in the subclaim(s).

In the case of a drive device having a main body and having at least one rotating unit, wherein the rotating unit is arranged mounted on the main body at least in a rotatable manner, wherein the rotating unit has at least one driven drive shaft, wherein the drive shaft drives at least one rotating body, wherein the rotating body has at least two swing weights, wherein the swing weights are arranged to be radially movable to the drive shaft, wherein the swing weights are arranged in pairs, wherein the swing weights are arranged on opposite sides of the drive shaft, and wherein the swing weights are connected to each other at a fixed distance from each other. Essentially to the invention, the rotating body has at least two pulse generators, the rotating body has at least one linear guide for the linear guidance of the at least two pulse generators radially to the drive shaft, the pulse generators are arranged on opposite sides of the drive shaft, at least one spring element is arranged between the pulse generators and the drive shaft, the spring elements are each designed to deflect each pulse generator along the linear guide, the rotating unit has at least one link plate for controlling the distance between pulse generators and the drive shaft during the rotation of the drive shaft, and the pulse generators are associated with the swing weights so as to transmit pulses.

In particular, the main body can be a flat base plate. The rotating units are held by the main body at least in a rotatable manner in relation to the main body. For example, the rotating units can also be held in a swivel and rotatable manner. In particular, the swivel mount can be a gimbal suspension. For example, a base plate can have openings in which the rotating units are held. In addition, the rotating units are rotatable in the openings of the base plate. The drive device may have three or more, preferably four or more, rotating units. In particular, the rotating body can be disc-like, for example, circular as a rotating disc. In particular, the drive shaft for driving the rotating body can be located in the centre point of the rotating body. A rotating body can be set in rotation by means of the drive shaft. The drive shaft can be driven by an electric motor or the like, for example. Each rotating body has at least two swing weights, wherein the swing weights are each mounted in a moveable manner radially to the rotating shaft. In particular, the swing weights can be two swing weights of the same shape and mass connected to each other at a fixed distance from each other. In one section of the rotation of the rotating body, there is an swing weight on or in the area of the drive shaft and the second swing weight is in an unbalanced position. In the balanced or almost balanced state, for example, both swing weights have the same distance to the drive shaft. When using two swing weights connected to each other at a fixed distance from each other, the swing weights can each have the same distance to the drive axle in the balanced or in the almost balanced state, i.e., in a semicircle of the rotation. The swing weights can, for example, be mounted on guide elements, such as guide rails or slide rails for example, wherein the guide elements are arranged radially on the rotating bodies starting from the rotational axis. The swing weights can be shifted radially to the rotational axis on the rotating bodies in such a way that there is an imbalance in a circular segment, i.e., in an angular section of the rotation, of the same rotation and that a balanced or approximately balanced movement is possible in a further angular section of the rotation. Preferably, the imbalances of all rotating bodies and all rotating units of a drive device are directed in the same direction and clocked in the same way. For example, swing weights can also be arranged parallel to each other on both sides of the rotating body, which can be moved synchronously in the same congruence. In order to bring the swing weights into an at least approximately balanced or unbalanced position, the rotating body has pulse bodies. To guide the pulse generators, the rotating body has a linear guide along which the pulse generators can be moved in a radial direction to the drive shaft. The pulse generators transfer a pulse to the respective swing weight, for example, by bumping together. By moving along the linear guide, the distance between the pulse generators and the drive shaft and thus the rotational axis is controlled, as well as the respective spring tension of the spring elements. By controlling one pulse generator in a rotation section, i.e., in an angular range of rotation, into a position further away from the rotational axis, while the other pulse generator is in a position closer to the drive shaft, a pulse can be achieved in one direction with appropriate pulse being transferred to the swing weights. Starting from the drive shaft, the linear guide of the rotating body extends in a radial direction on two opposite sides. For example, the linear guide can be formed by a slot-like recess in the rotating body, particularly in the rotating disc, wherein the pulse generators are guided in the linear guide in a radial direction. The pulse generators can therefore be moved along the radius of the rotating disc in the linear guide. At least two pulse generators are associated with the rotating body, wherein the pulse generators are arranged on a radius on opposite sides of the drive shaft. Spring elements are arranged between the pulse generators and the drive shaft. The spring elements can be compression springs in particular. The spring elements are arranged in such a way that the pulse generators are pushed away from the drive shaft in a radial direction when the spring elements are released, i.e., when the spring force is released. In order for a pulse generator to approach the drive shaft, the spring element must be compressed and thus the spring force must be applied. At least one link plate is associated with the rotating body to control the distance between the pulse generators and the drive shaft. In particular, the link plate may be aligned parallel to the guide body, i.e., in particular, to the guide disc, wherein the plane spanned by the guide body is arranged parallel to the plane spanned by the guide disc. The link plate has a slide guide for the pulse generators. The slide guide can be designed in particular through a guide opening into which the guide pins of the pulse generator can reach. For example, the guide pins can be cylindrical in shape and arranged perpendicular to the plane stretched by the rotating disc, i.e., by the rotating body. The rotating body is set in rotation by the drive shaft relative to the link plate so that the guide pins of the pulse generators are moved along the inner edge of the guide opening. In accordance with the shape of the guide opening, the pulse generators are moved along the linear guide during a rotation of the rotating body. In order to achieve a directed pulse of the drive device and a pulse transfer from the pulse generators to the swing weights, a pulse generator is moved close to the drive shaft in a section of the rotation, wherein the spring element is compressed. Meanwhile, the other pulse generator, located opposite the drive shaft, is located in a position further away from the drive shaft. In one section of the rotation, the change is made by moving the pulse generator, which is located further away from the drive shaft, through the guide opening of the link plate in the direction of the drive shaft, wherein the spring force must be applied to compress the spring element. Essentially at the same moment, the other pulse generator, which was closer to the drive shaft, is moved away from the drive shaft through the guide opening. This results in an abrupt relaxation of the spring force of the spring element so that the pulse generator is abruptly moved away from the drive shaft due to the centrifugal force acting during rotation and supported by the spring element. The pulse of the pulse generators is transferred to the radially movable swing weights, for example, by bumping together. The pulse transmission of a pulse generator can be carried out synchronously on two swing weights arranged on both sides of the rotating body. For example, when the spring element is relaxed, the pulse of the pulse generator can be transferred to a first swing weight by bumping together so that it is accelerated into a position of the outer radius of the rotating body. The other second swing weight, which is connected to the first swing weight at a fixed distance from each other, is moved closer to the drive shaft. The spring elements of the pulse generators dampen the swing weights before reaching their respective end positions. This allows a directed pulse of the entire drive device to be achieved, which can lead to a movement of the drive device if the pulse is transmitted accordingly. For this purpose, the drive device can have a plurality of rotating units in particular, which can generate an pulse controlled in parallel to each other. The pulse direction can be controlled by turning the link plates.

In a further embodiment of the invention, the rotating body is designed as a disc, the rotating body and at least one link plate are arranged parallel to each other, and the drive shaft of the rotating body is arranged perpendicular to the planes spanned by the rotating body and at least one link plate. The rotating body is disc-like, preferably circular disc-like. The rotating body and the link plate may be arranged parallel to each other so that the guide pins of the pulse generators, which extend perpendicular to the plane spanned by the link plate and the plane spanned by the rotating body, can grasp into the guide opening of the link plate. When the rotating body rotates relative to the link plate, the guide pins are guided along the inner edge of the guide opening of the link plate so that the respective distance of the pulse generators and thus indirectly of the swing weights to the drive shaft can be controlled by the link plate during rotation.

In one embodiment of the invention, the linear guide is designed as a guide slot. The linear guide of the rotating body can be designed as a slot-like recess. The slot-like recess extends radially in the rotating body from the drive shaft, i.e., in the direction of the radius to two opposite sides of the drive shaft.

In one embodiment of the invention, the rotating body is mounted around the rotational axis of the drive shaft independently of that of the link plate. The rotating body is driven by the drive shaft around its rotational axis, wherein the rotating body is moved independently of at least one link plate. The independent rotation of the rotating body to the backdrop disc enables control of the pulse.

In one embodiment of the invention, the link plate has a guide opening and the inner edge of the guide opening is designed to control the movement of the pulse generators along the linear guide. The guide pins of the pulse generators grip the guide opening and are moved along the inner edge of the guide opening relative to the link plate during the rotation of the rotating body. Here, the guide pins are pressed to the inner edge of the guide opening by the spring force of the spring elements. Depending on the shape of the guide opening, the pulse generators can thus be moved along the linear guide of the rotating body. The inner edge of the guide opening, for example, may have a friction-reducing coating. In particular, the guide opening may be designed in such a way that the spring element is first strongly compressed on a rotation section, i.e., in an angular section, and is subsequently compressed less strongly on a rotation section of the same length, i.e., in an angular section of the rotation of the same size. This is intended to keep the effort required during a rotation the same. The spring force required to compress one of the spring elements increases until the spring element is completely compressed.

In one embodiment of the invention, the distance between the inner edge of the guide opening and the drive shaft is different in the course of the inner edge and the distance is selected depending on the spring force of the spring elements. In particular, the guide opening can be designed in such a way that the one relaxed spring element is initially strongly compressed in a circular section when tensioned again by applying the spring force and is subsequently compressed less strongly on a circular section of the same length. This is intended to ensure that the force applied by the drive of the drive shaft remains the same during rotation. The spring force required to compress one of the spring elements increases until the spring element is completely compressed. In a first section, the guide opening has a greater gradient in relation to the drive shaft, which compresses the spring element more strongly in a smaller angular section of the rotation. As it progresses, the gradient of the outer edge of the guide opening flattens out, so the spring element is less compressed on the same angular section as in the first area. This results in a constant amount of force to compress the spring element during rotation. In one embodiment of the invention, the pulse generators each have at least one guide pin and the guide pins reach into the guide opening of the link plate. The pulse generators each have at least one guide pin arranged perpendicular to the plane spanned by the rotating body, or the plane spanned by the guide slot. Due to the perpendicular arrangement to the rotating body, a guide pin can reach into the guide opening of the link plate, which is arranged parallel to the rotating body.

In one embodiment of the invention, the shape of the guide opening is essentially formed by two essentially semicircular surfaces, wherein a first essentially semicircular surface has a larger radius than a second essentially semicircular surface. It is provided that a pulse generator and thus a swing weight during a rotation of the rotating body is first in a position further away from the drive shaft and then transferred to a position closer to the drive shaft. As a result, two essentially semicircular surfaces are used as the form of the guide opening of the link plate. The essentially semicircular surfaces from which the guide opening of the link plate is constructed can also be hyperbolas, ellipses or the like. If the guide pin of the pulse generator travels along the inner edge of the larger one, which is essentially semicircular, the pulse generator is further away from the rotary shaft. In the section where the guide opening is given by the smaller, essentially semicircular surface, the pulse generator is moved along the linear guide to the drive shaft. The diameters of the two, which are essentially semicircular, are essentially arranged opposite each other, in particular, lying on a line. On this line, which can also have a non-straight shape, the centre points or the focal points of the essentially semicircular surfaces, i.e., the points around which the respective radius of the semicircle or the ellipses is constructed, are also accordingly arranged. The rotational axis of the drive shaft can also be on this line. The centre points of the circle are staggered on this line. By arranging the centre points or focal points and selecting the respective radii, the position of the pulse generators can be adjusted during the rotation of the rotating body. The larger a radius of a semicircle or ellipse is chosen, the further away the swing weight is from the drive shaft.

In one embodiment of the invention, the centre points of the circles of the essentially semicircular surfaces are arranged lying on one and the same line and the centre points of the circle are offset on the line with respect to each other. The arrangement of the semicircular centres, or the focal points of ellipses, on a line and the offset arrangement in relation to each other enables a transition of the movement of the pulse generators from a position located near the drive shaft to a position away from the drive shaft.

In one embodiment of the invention, the radius of the first larger, essentially semicircular surface is considerably greater than the radius of the smaller second, essentially semicircular surface. The ratio of the radii of the two essentially semicircular surfaces to each other can be used to determine the ratio of the distances of the pulse generators in the position further away from the drive shaft to the position near the drive shaft. In particular, the radius of the small semicircular surface may be adapted to the minimum space required by a compressed spring element between the drive shaft and the pulse generator. The radii of the semicircular surfaces thus determine the respective spring tension between the pulse generators and the drive shaft.

In a preferred embodiment of the invention, the rotating unit has two link plates, the link plates are arranged on both sides parallel to the rotating body and the guide openings of the link plates are congruently arranged. Preferably, a pulse generator has a guide pin that protrudes on both sides from the plane spanned by the rotating body and grips on both sides into the guide opening of the link plates arranged there. The guide openings of the link plates are arranged congruently so that the guide pin is guided by both link plates in the same way. This provides a considerably more stable guidance of the pulse generators.

In an embodiment of the invention, each rotating unit is assigned a second rotating unit with drive shafts driven in the opposite direction of rotation. In order to achieve the most stable drive of the drive device, the rotating units are each designed in pairs, wherein the rotation directions run in opposite directions. This results in a more stable drive of the drive device.

In an embodiment of the invention, at least two swing weights are arranged in a sliding position on a guide element. For example, a guide element, in particular a slide rail, may be arranged around the linear guide of the pulse generators so that on this guide element the swing weights connected to each other at a fixed distance from each other can be arranged in a sliding manner parallel to the pulse generators. For bearings, the guide element can also have ball bearings, plain bearings or the like. The swing weights can be triggered by the pulse generators or by the guide pins of the pulse generators so that the pulse is transferred from the pulse generators to the swing weights. The connection between the swing weights at a fixed distance from each other can be formed, for example, via a linkage or similar. For example, the connection can be rigidly formed at a fixed distance from each other. In particular, due to the rigid connection, there can always be an equal distance between the swing weights. An pulse that is transferred to a first swing weight is thus transferred directly to the second swing weight.

In a further embodiment of the invention, the rotating body has a plurality of sliding elements, and the guide elements extend radially to both sides of the drive shaft. The rotating body can have a plurality of swing weights. The swing weights are each connected in pairs at a fixed distance from each other, for example via a linkage. Two swing weights can be arranged on a sliding element. The guide elements extend radially from the drive shaft on both sides. Preferably, the guide elements are arranged at the same distance from each other, in particular, the angles between adjacent guide elements are the same. During the rotation of the rotating body relative to the link plate, the pulse generator is moved in such a way that it bumps the swing weights one after the other. Thus, pulses can be transmitted to a plurality of swing weights by two rotating pulse generators. Guide elements can also be arranged on both sides of the rotating body, in particular, congruently.

Furthermore, the rotating body can have a plurality of linear guides, each of which extends in a radial direction to both sides of the drive shaft. In particular, the linear guides can be evenly distributed on the rotating body. The angles between two adjacent linear guides can be the same. Two swing weights arranged on one side of the rotating body or two swing weight pairs, one swing weight pair on each side of the rotating body, can be associated with a linear guide with two pulse generators.

In one embodiment of the invention, the pulse generators are arranged in a radial direction between the drive shaft and the respective swing weight. The arrangement of the pulse generators between the drive shaft and the swing weight in the radial direction enables the transmission of the pulse from the pulse generators or from the guide pins of the pulse generators to the swing weights. For example, when the pulse generator moves away from the drive shaft, i.e., when the respective spring element is relaxed, the swing weight can be moved to a position on the outer radius of the rotating body. By placing the pulse generator between the drive shaft and the swing weight, the swing weight can thus receive an pulse from the pulse generators.

### BRIEF DESCRIPTION OF THE DRAWINGS

In the following, an embodiment of the invention is shown in more detail in the drawing. In detail, the schematic representations show:

FIG. 1: a rotating unit with a rotating body and two link plates in a perspective view;

FIG. 2: a rotating unit in accordance with FIG. 1 in a lateral view;

FIG. 3: a rotating unit in accordance with FIG. 1 in another lateral view;

FIG. 4: a rotating unit in accordance with FIG. 1 with swing weights and slide rail.

### DETAILED DESCRIPTION OF THE PREFERRED EMBODIMENTS

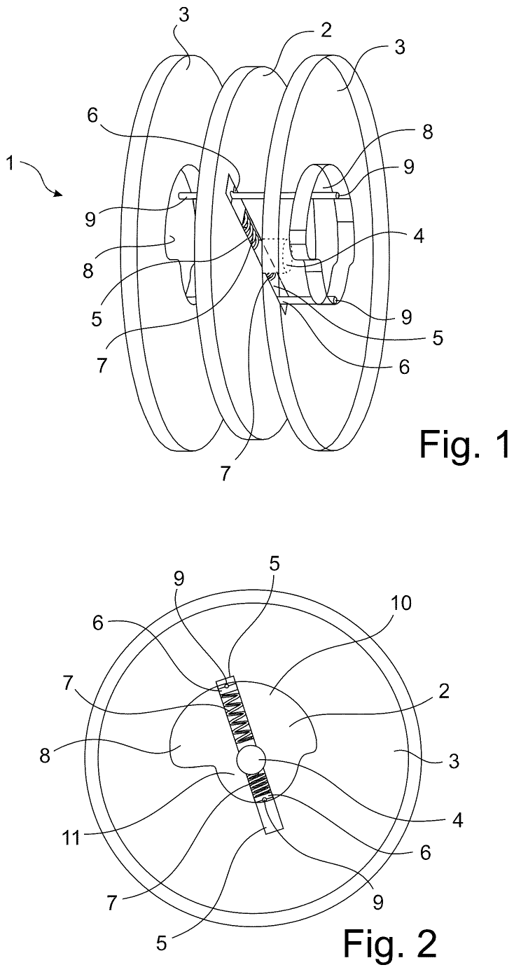

FIG. 1 shows a rotating unit 1 with a disc-like rotating body 2 and two link plates 3 arranged parallel to the rotating body 2. The rotating body 2 is set into rotation by a drive shaft 4. The rotating body 2 has a linear guide 5 in which pulse generators 6 are guided. The linear guide 5 is designed as a slot-like recess in the rotating body 2 and extends to two opposite sides of the drive shaft 4 in a radial direction. Spring elements 7 are arranged between the pulse generators 6 and the drive shaft 4, which can be designed as compression spring elements. The spring elements 7 are designed in such a way that the pulse generators 6 are pushed away from the drive shaft 4 along the linear guide 5 by the spring elements 7. On both sides of the rotating body 2, link plates 3 are arranged parallel to the rotating body 2. The rotating body 2 is rotated by the drive shaft 4 relative to the link plates 3. The pulse generators 6 each have guide pins 9, which are arranged perpendicular to the plane of rotation, i.e., to the plane spanned by the rotating body 2. The guide pins 9 hold into the guide openings 8 of the link plates 3 and are moved along the inner edges of the guide openings 8 during the rotation of the rotating body 2. In this case, the guide pins 9 are pressed to the inner edge of the guide opening 8 by the acting spring force of the spring elements 7. Through the guide openings 8 of the link plates 3, the distance of the pulse generator 6 to the drive shaft 4 is controlled along the linear guide 5. Thus, one pulse generator can be moved closer to the drive shaft 4, while the other pulse generator is simultaneously moved to a position further away from the drive shaft 4, essentially supported by the centrifugal force and the relaxing spring force of the spring element 7. This can generate a directional pulse.

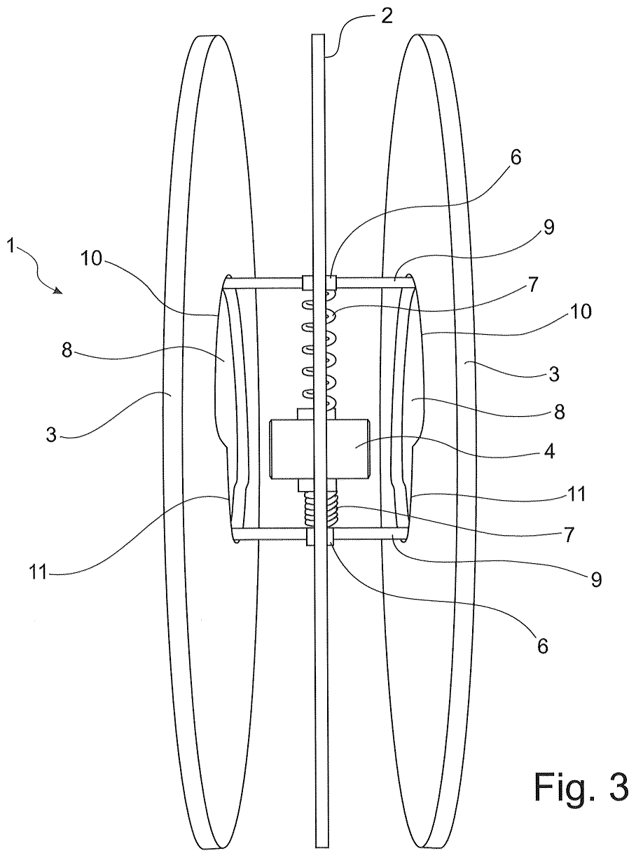

In FIG. 2, a rotating unit 1 is shown in a lateral view in accordance with FIG. 1. Identical components are provided with the same reference numbers. The shape of a guide opening 8 of a backdrop disc 3 is essentially formed by the surface areas of two semicircles 10, 11. By the larger section 10 the pulse generator 6 is moved to a position further away from the drive shaft 4. Through the smaller section 11, the corresponding pulse generator 6 is moved further in the direction of the drive shaft 4 during the rotation of the rotating body 2 along the linear guide 5.

In FIG. 3, the rotating unit 1 is shown in a further lateral view in accordance with FIG. 1. Identical components are provided with the same reference numbers. The link plates 3 can be rotated parallel to each other, in particular so that the guide openings 8 remain congruent in order to control the direction of the directed pulse.

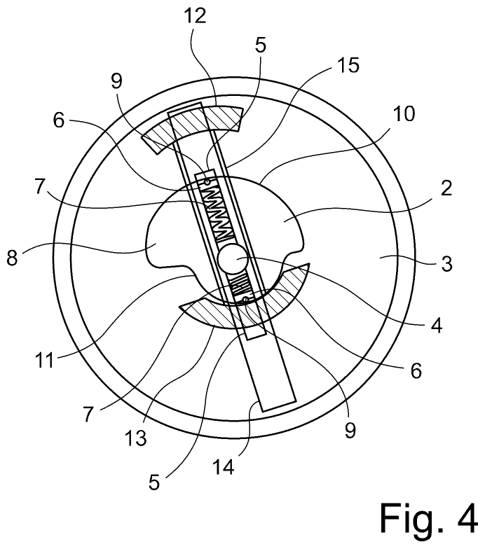

FIG. 4 shows a rotating unit 1 in accordance with FIG. 1. The rotating body 2 has swing weights 12, 13, which are arranged on a guide element, in this case a slide rail 14. The slide rail 14 is arranged around the linear guide 5. The swing weights 12, 13 are connected to each other by a fixed distance from each other, in particular by a rigid connection 15, which can be formed by a linkage, for example. Due to the rigid connection 15, the swing weights 12, 13 always have the same distance from each other. Through the pulse generator 6, a pulse is transferred to the swing weight 12 so that it is now in the position at the outer radius of the rotating body 2. Accordingly, the swing weight 13 was moved to a position in the direction of the drive shaft 4, wherein the spring element 7 between the swing weight 13 and the drive shaft 4 is tensioned again. In the further movement, a pulse would now be transferred to the swing weight 13 by the pulse generator 6. In this case, the spring element 7 would relax.

1. A drive device having a main body and having at least one rotating unit wherein the rotating unit is arranged on the main body in a rotatable manner at least, wherein the rotating unit has at least one driven drive shaft, wherein the drive shaft drives at least one rotating body, wherein the rotating body has at least two swing weights wherein the swing weights are arranged to be radially movable to the drive shaft, wherein the swing weights are arranged in pairs, wherein the swing weights, are arranged on opposite sides of the drive shaft and wherein the swing weights, are connected to each other at a fixed distance from each other,
wherein
the rotating body has at least two pulse generators
the rotating body has at least one linear guide for linear guidance of the at least two pulse generators radially to the drive shaft,
the pulse generators are arranged on opposite sides of the drive shaft,
at least one spring element is arranged between the pulse generators and the drive shaft,
the spring elements are each designed for the deflection of the respective pulse generator along the linear guide
the rotating unit has at least one link plate for controlling the distance of the pulse generators to the drive shaft during the rotation of the drive shaft, and
the pulse generators are associated with the swing weights, in a pulse transmitting manner.

2. The drive device according to claim 1, wherein the rotating body is designed in a disc-like manner, that the rotating body and at least one link plate are arranged parallel to each other, and that the drive shaft of the rotating body is arranged perpendicular to the planes spanned by the rotating body and at least one link plate

3. The drive device according to Claim 1, wherein the linear guide is designed as a guide slot.

4. The drive device according to Claim 1, wherein the rotating body is mounted around the rotational axis of the drive shaft independently from the link plate.

5. The drive device according to Claim 1, wherein the link plate has a guide opening and that the inner edge of the guide opening is designed to control the movement of the pulse generators along the linear guide.

6. The drive device according to claim 5, wherein the distance of the inner edge of the guide opening to the drive shaft is of different sizes in the progression of the inner edge and that the distance is chosen depending on the spring force of the spring elements.

7. The drive device according to Claim 5, wherein the pulse generators each have at least one guide pin and that the guide pins engage in the guide opening of the link plate.

8. The drive device according to Claim 5, wherein the shape of the guide opening is essentially formed by two essentially semicircular surfaces, wherein a first essentially semicircular surface has a greater radius than an essentially second semicircular surface.

9. The drive device according to claim 8, wherein the centre points of the circles of the essentially semicircular surfaces are arranged lying on one and the same line and that the centre points of the circle are offset on the line from each other.

10. The drive device according to Claim 8, wherein the radius of the first larger substantially semicircular surface is considerably greater than the radius of the smaller second substantially semicircular surface.

11. The drive device according to Claim 1, wherein-the rotating unit has two link plates, that the link plates are arranged on both sides parallel to the rotating body and that the guide openings of the two link plates are arranged congruently with respect to each other.

12. The drive device according to Claim 1, wherein each rotating unit is assigned a second rotating unit with drive shaft driven in the opposite direction of rotation.

13. The drive device according to Claim 1, wherein at least two swing weights are each mounted on a guide element in a sliding manner.

14. The drive device according to Claim 1, wherein the rotating body has a plurality of guide elements and that the slide rails extend radially to both sides of the drive shaft.

15. The drive device according to Claim 1, wherein the pulse generators are arranged in a radial direction between the drive shaft and the respective swing weight.
